(19) United States
(12) Patent Application Publication
(10) Pub. No.: US 2013/0292613 A1
(43) Pub. Date: Nov. 7, 2013

(54) CATHODE MATERIAL FOR A LITHIUM-SULFUR BATTERY

(71) Applicants: Marcus Wegner, Leonberg (DE); Martin Tenzer, Unterensingen (DE); Jean Fanous, Stuttgart (DE)

(72) Inventors: Marcus Wegner, Leonberg (DE); Martin Tenzer, Unterensingen (DE); Jean Fanous, Stuttgart (DE)

(21) Appl. No.: 13/883,658

(22) PCT Filed: Sep. 12, 2011
(86) PCT No.: PCT/EP2011/065702

§ 371 Date: Jul. 19, 2013

(30) Foreign Application Priority Data
Nov. 4, 2010 (DE) 10 2010 043 400.0

(51) Int. Cl. H01M 4/36

(52) U.S. Cl. CPC H01M 4/364
USPC 252/511; 252/502; 252/500

(57) ABSTRACT

A method for producing a cathode material for a cathode of a galvanic cell, such as a lithium or natrium sulfur cell. In order to improve the electric and ionic conductivity, the sulfur accessibility and utilization, elemental sulfur, at least one electrically conductive component and a solvent or a solvent mixture are mixed in method step a), the elemental sulfur being completely dissolved in the solvent or in the solvent mixture, and the solvent or solvent mixture is removed in a method step b).

### FIELD

The present invention relates to a method for producing a cathode material for a cathode of a galvanic cell, or for producing a cathode of a galvanic cell, and to such a cathode material, such a cathode or such a galvanic cell.

### BACKGROUND INFORMATION

At present, research in connection with lithium-sulfur technology is taking place in order to produce batteries that provide a considerably greater energy density. Theoretically, this technology could make it possible to achieve energy densities of more than 1,000 Wh/kg. However, to do so, the cathode of the galvanic element would have to be made completely of elemental sulfur. However, since elementary sulfur is neither ionic nor electrically conductive, conductive additives such as soot, graphite and carbon nanotubes are added to the cathode mixture, which markedly lower the energy density.

One method for producing cathodes for lithium-sulfur batteries is based on dispersing sulfur particles and a conductive additive in a fluid. The particle size amounts to approximately 20 μm to 30 μm, depending on the dispersing parameters. The sulfur particles in cathodes produced in this manner are detectable using scanning electron microscopy (SEM). Cathodes produced in this way typically have an energy density of approximately 300 Wh/kg and a sulfur utilization of approximately 30%.

German Patent Application No. DE 699 06 814 T2 describes a further development of this method, in which a sulfur-containing material and an electrically conducting material are dispersed or suspended in a liquid medium, the dispersion or the suspension is poured onto a substrate, the liquid medium is removed and the sulfur-containing material is melted and then solidified again.

Another method for producing cathodes for lithium-sulfur batteries is based on heating elemental sulfur and polyacrylonitrile (PAN) to 280° C. to 600° C. In so doing, the sulfur binds with the developing cyclized polyacrylonitrile, a polymer with a conjugated E-system. Elemental sulfur is unable to be resolved using scanning electron microscopy. Cathodes produced in this way typically have an energy density of approximately 350 Wh/kg.

### SUMMARY

In accordance with the present invention, a method is provided for producing a cathode material for a cathode (positive pole in the discharge operation) of a galvanic cell, or for producing a cathode of a galvanic cell, especially an alkali-sulfur cell/battery, such as a lithium or natrium-sulfur cell/battery.

According to an example embodiment of the present invention, the method includes the method steps of:

a) Mixing elemental sulfur, at least one electrically conducting component and a solvent or solvent mixture, the elemental sulfur being completely dissolved in the solvent or solvent mixture; and

b) Removing the solvent or solvent mixture.

The example method according to the present invention has the advantage that better dispersion and mixing of the sulfur and the electrically conducting component is able to be achieved in the cathode matrix, since molecules are dispersed more finely in a solution than in a dispersion or suspension. Thus, even nano-scale intermixing is advantageously able to be achieved. Because of such a dispersion and thorough mixing of the sulfur and the electrically conducting component, the electric and ionic conductivity of the cathode as well as the sulfur accessibility and sulfur utilization, is able to be improved considerably, especially given the same sulfur content. In particular, at a high sulfur content of more than 50% or 60%, significantly higher sulfur utilization is thereby obtainable. Over all, significantly higher energy densities than in conventional lithium/natrium-sulfur batteries are advantageously able to be realized.

The mixing of the components and the dissolving of the sulfur in method step a) are able to take place both partially or completely simultaneously, and also consecutively.

For example, the elemental sulfur, the electrically conductive component and the solvent or solvent mixture are able to be supplied and mixed in random order, the sulfur going completely into the solution in the course of the mixing.

Within the framework of one development, however, a solution of elemental sulfur and the solvent or the solvent mixture is produced to begin with in method step a), whereupon the at least one electrically conducting component is added to the mixture. A solution is a homogeneous substance mixture made up of a solvent, or multiple solvents, and one or more substances dissolved therein, such as elemental sulfur, which in particular is not separable by filtration and centrifugation. Heterogeneous substance mixtures, such as dispersions and suspensions, are not considered solutions within the scope of the present invention.

Preferably, the solvent or solvent mixture and the at least one electrically conducting component do not enter into a chemical reaction or do not bind to the elemental sulfur in method step a), in particular a reaction in which the sulfur leaves oxidation stage 0, for instance at a large proportion (more than 10 mole percent of the sulfur) and/or irreversibly. This advantageously makes it possible to maintain the average voltage, and to avoid that the average voltage drops by approximately 0.1 V-0.3 V, as it was encountered in the PAN concept and other systems having polymer sulfur bonds. This makes it possible to achieve a greater output given the same capacitance.

Within the framework of another specific development, the at least one electrically conducting component is selected in method step a) from the group consisting of electrically conducting polymers, polymers which are convertible into electrically conducting polymers, carbon modifications, especially graphite, soot and/or carbon nanotubes, and combinations thereof. The at least one electrically conducting component may be selected in method step a) in particular from the group made up of electrically conducting polymers, carbon modifications, especially graphite, soot and/or carbon nanotubes, and combinations thereof.

Within the framework of another specific embodiment, the electrically conducting component in method step a) is an electrically conducting polymer or a mixture of electrically conducting polymers. Electrically conducting polymers have shown to be especially advantageous because they are soluble in suitable solvents, so that better dispersion and thorough mixing of the sulfur and the electrically conducting component are able to be achieved. The electrically conducting component in method step a) in particular may be an intrinsically conducting polymer or a mixture of intrinsically conducting polymers. An intrinsically conducting polymer in particular may be a polymer which has a conjugated n-electron system.

Within the framework of another specific embodiment, the at least one electrically conducting component in method step a) is selected from the group made up of polythiophene and polythiopene derivatives, polypyrrole and polypyrrole derivatives, polyaniline and polyaniline derivatives, polyparaphenylene and polyparaphenylne derivatives, polyacetylene and polyacetylene derivatives and combinations thereof. In particular, in method step a) the at least one electrically conducting component may be selected from the group made up of polythiophene and polythiophene derivatives, e.g., poly-3-alkyl thiophene (P₃AT), e.g., poly-3-ethyl thiophene, poly-3-buty thiophene, poly-3-hexyl thiophene, poly-3-octyl thiophene, poly-3-decyl thiophene, poly-3-dodecyl thiophene and combinations thereof. Especially because of the solubility and the film-forming characteristics of polythiophene derivatives, e.g., poly-3-alkyl thiophenes (P₃AT), it is advantageously possible to produce cathodes which have excellent contacting between the cathode matrix and sulfur, without producing a covalent bond between the conducting polymer and sulfur. This advantageously makes it possible to obtain both a very fine sulfur distribution and a high average voltage.

Within the framework of another specific embodiment, the at least one electrically conducting component is likewise completely dissolved in the solvent or the solvent mixture in method step a). This advantageously achieves improved distribution and thorough mixing of the sulfur and the electrically conducting component.

Within the framework of another specific development, the solvent or the solvent mixture is selected from the group of organic solvents and organic solvent mixtures. The solvent in particular may be selected in such a way that it does not form a gel.

Within the framework of another specific development, the solvent or the solvent mixture is selected from the group made up of aromatic hydrocarbons, such as tuloene, phenol, xylol, benzole and/or chlorobenzene, heterocyclic compounds, such as N-methyl-2-pyrrolidone (NMP), and combinations thereof. In particular, the solvent or the solvent mixture may be selected from the group made up of aromatic hydrocarbons such as toluene, phenol, xylol, benzole and/or chlorobenzene, and combinations thereof. Such solvents and solvent mixtures have shown to be advantageous within the framework of the present invention.

Within the framework of another specific development, in method step a), the mixture is heated to a temperature in a range from ≧20° C. to <280° C. or from ≧30° C. to <250° C., in particular from ≧50° C. to ≦200° C., such as from ≧50° C. to ≦150° C., especially in order to produce the sulfur solution. Heating the mixture in method step a) advantageously makes it possible to increase the solubility of the elemental sulfur and also the electrically conducting component in the solvent or the solvent mixture. However, the mixture should not be heated to excess in method step a) in order to prevent a reaction between the sulfur and the electrically conducting component or a decomposition of the electrically conducting component.

Within the framework of another specific embodiment, the method furthermore includes, especially following method step a) and prior to method step b), the method step:
a1) admixing of at least one further electrically conducting component, e.g., one or more carbon modifications such as graphite, soot and/or carbon nanotubes, to the mixture from method step a).

The further electrically conducting component added to the mixture in method step a1) may likewise either be dissolved or dispersed or suspended in the mixture or solution from method step a), in particular completely. In particular, the further electrically conducting component added to the mixture in method step al) may be dispersed or suspended in the mixture or solution from method step a).

Preferably, the components are stirred in method step a) and/or a1). This advantageously makes it possible to achieve thorough mixing.

The mixture from method step a) or a1) may be applied both directly on a substrate, e.g., a cathode current collector, made of aluminum, for example, and solidified thereon by removing the solvent or the solvent mixture.

Within the framework of one specific embodiment, especially following method step a) or a1) and prior to method step b), the method therefore includes the method step:
b0) depositing the mixture from method step a) or a1) on a substrate, such as a cathode current collector, for instance made of aluminum.

The application may take the form of raking. This advantageously makes it possible to produce cathode material layers having a low layer thickness, e.g., from ≧10 μm to ≦150 μm or from ≧10 μm to ≦100 μm, which are particularly suitable for high currents.

However, it is also possible to first rid the mixture from method step a) or a1) of the solvent or solvent mixture in method step b) and to deposit it, dispersed, suspended or dissolved in some other solvent or solvent mixture, for example, on a substrate such as a cathode current collector made of aluminum, for instance, in a later method step.

In order to produce cells having high energy densities—in relation to the total weight of the cell—it is also possible to produce cathode material layers with a greater layer thickness, such as more than 100 μm or more than 120 μm or more than 150 μm. To do so, preferably at least one binder is admixed in addition.

Within the framework of another specific embodiment, at least one binder is therefore added to the mixture in method step a) or a1). For example, the at least one binder may be selected from the group made up of fluorinated polymers, polyacrylates, polyethylene oxides, water-soluble binders such as cellulose as well as cellulose derivatives, and combinations thereof. Inasmuch as the solvent or the solvent mixture from method step a) or a1) is first removed from the mixture from method step a) or a1) in method step b), and the mixture, dispersed, suspended or dissolved in another solvent or solvent mixture, is applied on a substrate, e.g., a cathode current collector, in a later method step, the at least one binder is able to be admixed to the other solvent or solvent mixture as well.

With regard to additional advantages and features of the method according to the present invention, explicit reference is made here to the explanations in connection with the cathode material, the cathode, the cell and the use according to the present invention, and to the description of the figures.

Another subject matter of the present invention is a cathode material or a cathode, especially for an alkali-sulfur cell/battery, e.g., for a lithium or natrium-sulfur cell/battery, which is produced by a method according to the present invention.

With regard to additional advantages and features of the cathode material and the cathode according to the present invention, explicit reference is made here to the explanations in connection with the method according to the present invention, the cell and the use according to the present invention, and the description of the figures.

Another subject matter of the present invention is a galvanic cell, especially an alkali-sulfur cell/battery, e.g., a lithium or natrium-sulfur cell/battery, which includes a cathode material or a cathode according to the present invention. Such galvanic cells may be used for all applications that are equipped with a battery or accumulators.

This may be, for example, electric or hybrid vehicles, electric tools, garden devices, multimedia and/or communication devices such as notebooks, mobile phones, PDAs, electronic books etc., or also stationary energy storage systems for houses or plants. Due to the high energy densities, such galvanic cells are suitable in particular for electric or hybrid vehicles and stationary energy storage systems.

With regard to additional advantages and features of the galvanic cell according to the present invention, explicit reference is made here to the explanations in connection with the method according to the present invention, the cathode material, the cathode, and the use according to the present invention, as well as to the description of the figures.

Another subject matter of the present invention is the use of a solution which includes an organic solvent or a solvent mixture of organic solvents, and contained therein, in particular in completely dissolved form, elemental sulfur, for producing a cathode material or a cathode of an alkali-sulfur cell/battery, especially a lithium or natrium-sulfur cell/battery.

With regard to additional advantages and features of the use according to the present invention, explicit reference is made here to the explanations in connection with the example method according to the present invention, the example cathode material, the example cathode, and the example cell according to the present invention, as well as to the description of the figure.

### BRIEF DESCRIPTION OF THE DRAWING

Further advantages and advantageous refinements of the subject matters of the present invention are illustrated by the figure and explained in the description below. In this context, it should be noted that the figure has only descriptive character and is not intended to limit the present invention in any form.

FIG. 1 shows a graph to illustrate the voltage characteristic of a lithium-sulfur cell having a cathode which is produced by a specific development of a method according to the present invention.

### DETAILED DESCRIPTION OF EXAMPLE EMBODIMENTS

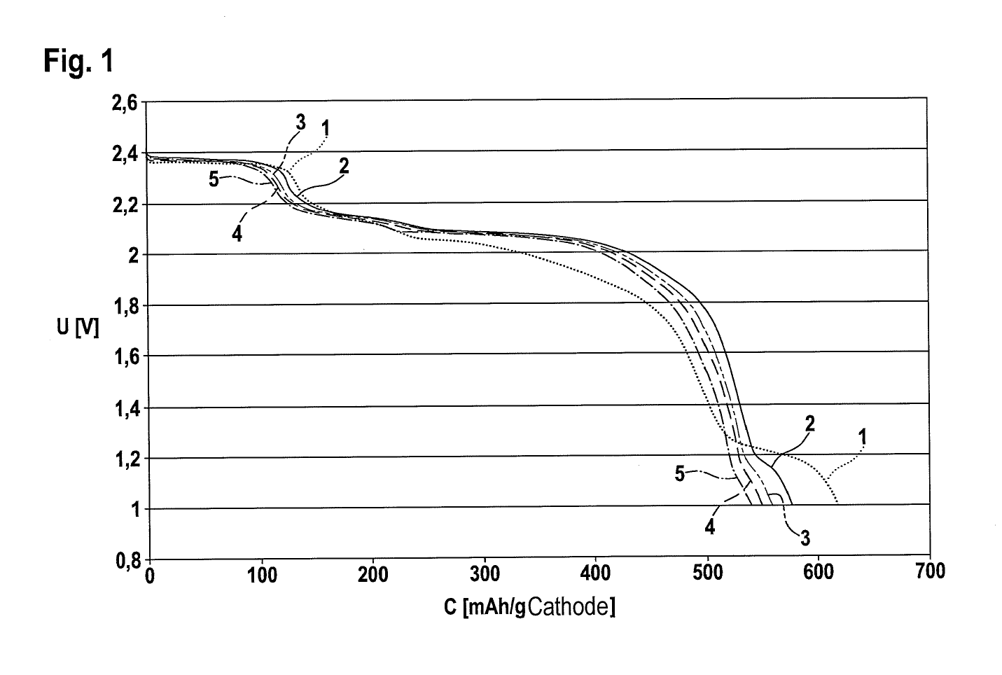

FIG. 1 shows a voltage characteristic of a lithium-sulfur cell having a cathode which is produced by a specific development of an example method according to the present invention.

To produce the cathode, 0.11 g of elemental sulfur was dissolved in 7 ml toluene at a temperature of 50° C. Then, 0.05 g poly-3-hexyl thiopene was added and the solution stirred for 60 minutes. Next, 0.03 g graphite and 0.02 g soot were added and the resulting dispersion stirred for another 60 minutes.

The cathode slurry produced in this manner is raked onto an aluminum foil and dried on a heating plate at 60° C. The layer thickness in the dried state amounts to 15 μm to 20 μm.

FIG. 1 shows the discharge profile of a lithium-sulfur cell having a cathode obtained in this manner for the first to the fifth charge cycle. FIG. 1 illustrates that both high capacities of more than 550 mAh/g of cathode material and a high average voltage of 2.1 V were achieved. This results in an energy density of approximately 500 Wh/kg. The cycle stability is able to be increased further by various parameters, e.g., a greater layer thickness of the cathode material.

1-15. (canceled)

16. A method for producing a cathode material for a cathode of a galvanic cell, comprising:
a) mixing elemental sulfur, at least one electrically conducting component, and one of a solvent or solvent mixture, the elemental sulfur being completely dissolved in the solvent or solvent mixture; and
b) removing the solvent or solvent mixture.

17. The method as recited in claim 16, wherein in step a), a solution of elemental sulfur and the solvent or the solvent mixture is produced first, whereupon the at least one electrically conducting component is added.

18. The method as recited in claim 16, wherein in step a), the at least one electrically conducting component is selected from the group made up of electrically conducting polymers, polymers which are convertible into electrically conducting polymers, carbon modifications, graphite, soot, carbon nanotubes, and combinations thereof.

19. The method as recited in claim 16, wherein the electrically conductive component in step a) is one of an electrically conductive polymer or a mixture of electrically conductive polymers.

20. The method as recited in claim 16, wherein the electrically conductive component in step a) is one of an intrinsically conductive polymer or a mixture of intrinsically conductive polymers.

21. The method as recited in claim 16, wherein in step a), the at least one electrically conductive component is selected from the group made up of polythiopene and polythiophene derivatives, polypyrrole and polypyrrole derivatives, polyaniline and polyaniline derivatives, polyparaphenylene and polyparaphenylene derivatives, polyacetylene and polyacetylene derivatives, polythiophene and polythiophene derivatives and combinations thereof.

22. The method as recited in claim 16, wherein the at least one electrically conducting component is also completely dissolved in the solvent or the solvent mixture in step a).

23. The method as recited in claim 16, wherein the solvent or the solvent mixture is selected from the group of organic solvents and organic solvent mixtures.

24. The method as recited in claim 16, wherein the solvent or the solvent mixture is selected from the group made up of aromatic hydrocarbons, especially toluene, heterocyclic compounds and combinations thereof.

25. The method as recited in claim 16, wherein the mixture is heated to a temperature in a range from ≧20° C. to <280° C. in step a).

26. The method as recited in claim 16, wherein the mixture is heated to a temperature in a range from ≧50° C. to <200° C. in step a)

27. The method as recited in claim 16, further comprising:
a1) admixing at least one further electrically conducting component to the mixture from step a).

28. The method as recited in claim 27, wherein the at least one further electrically conductive component includes at least one or more carbon modifications.

29. The method as recited in claim 16, further comprising:
b0) depositing the mixture from method step a) on a substrate.

30. The method as recited in claim 29, wherein the mixture is deposited on a cathode current collector.

31. The method as recited in claim 16, wherein at least one binder is additionally admixed in step a).

32. A cathode material or cathode for an alkali-sulfur cell, the cathode material or cathode being formed by mixing elemental sulfur, at least one electrically conducting component, and one of a solvent or solvent mixture, and then removing the solvent or solvent mixture.

33. A galvanic cell including a cathode material or a cathode, the cathode material or cathode being formed by mixing elemental sulfur, at least one electrically conducting component, and one of a solvent or solvent mixture, and then removing the solvent or solvent mixture.

34. A method for producing a cathode of an alkali-sulfur cell, the method comprising:
a) mixing elemental sulfur, at least one electrically conducting component, and one of a solvent or solvent mixture, the elemental sulfur being completely dissolved in the solvent or solvent mixture, and
b) removing the solvent or solvent mixture.
